(19) United States
(12) Patent Application Publication
(10) Pub. No.: US 2012/0134541 A1
(43) Pub. Date: May 31, 2012

(54) OBJECT TRACKING DEVICE CAPABLE OF DETECTING INTRUDING OBJECT, METHOD OF TRACKING OBJECT, AND STORAGE MEDIUM

(75) Inventor: Takayuki Hara, Yokohama-shi (JP)

(73) Assignee: CANON KABUSHIKI KAISHA, Tokyo (JP)

(21) Appl. No.: 13/306,304

(22) Filed: Nov. 29, 2011

(30) Foreign Application Priority Data
Nov. 29, 2010 (JP) 2010-264958
Nov. 15, 2011 (JP) 2011-249614

(51) Int. Cl. G06K 9/00

(52) U.S. Cl. 382/103

(57) ABSTRACT

An object tracking device that is capable of detecting that an intruding object has entered an image frame of image data where a tracking target object is being tracked. A plurality of sub areas are set in a preceding or current frame target area indicative of a position of the tracking target object in a preceding or current frame of moving image data, and a feature value of each sub area is determined. If the feature value exceeds a first threshold value in at least one of the sub areas and at the same time the number of the at least one of the sub areas does not reach a reference value, it is determined that an intruding object different from the tracking target object has entered an area in which the tracking target object is positioned in the current frame.

### BACKGROUND OF THE INVENTION

1. Field of the Invention

The present invention relates to an object tracking device that tracks a moving object, such as an object to be photographed, a method of tracking an object, and a storage medium storing an object tracking program, and particularly to an object tracking device that is capable of improving the accuracy of tracking by detecting an intruding object, which can be a cause of an error in tracking a moving object as a tracking target (tracking target object), a method of tracking an object, and a storage medium storing an object tracking program implementing the method.

2. Description of the Related Art

In general, an object tracking device is used for detecting a moving object (tracking target object), such as an object which is a tracking target, from moving image data, and tracking the same. As an example of a tracking method used in the object tracking device, first, a feature value of a tracking target object is calculated in a first frame of the moving image data. Then, in image data of each of the next frame et seq. following the first frame, a similar area is searched for which has a feature value most approximate to the feature value of the tracking target object, and a position of the similar area is set as a position of the tracking target object in the image data of the frame.

For example, Japanese Patent Laid-Open Publication No. H05-205052 discloses a configuration that performs tracking of a tracking target object using a color of the tracking target object as the feature value.

Further, Japanese Patent Laid-Open Publication No. 2006-318345 discloses a configuration that detects a plurality of similar areas which have feature values approximate to the feature value of a tracking target object, calculates a degree of reliability with respect to all of the detected similar areas, and sets a position of a similar area which is high in the degree of reliability as the position of the tracking target object.

However, the above-mentioned conventional tracking methods have the following problem.

FIG. 12 is a diagram useful in explaining the problem of the conventional tracking methods.

In FIG. 12, now, it is assumed that a bust of a person 1201 in image data of a (n−2)th frame (n is an integer more than two) in moving image data is set as a tracking target object. In the image data of the (n−2)th frame, a tracking frame 1200 is displayed over the bust of the person 1201.

In the image data of the (n−2)th frame, a person 1202 similar to the person 1201 exists in the vicinity of the person 1201 as the tracking target object. Further, in image data of a (n−1)th frame following the (n−2)th frame, an intruding person 1203 appears.

In image data of a nth frame following the (n−1)th frame, the intruding person 1203 stands in front of the person 1201, and covers the person 1201 as the tracking target object. In such a state, if the person 1201 as the tracking target object is tracked using the representative color or the feature value, since the person 1201 is covered by the intruding person 1203 in the image data of the nth frame, the tracking frame 1200 sometimes moves to the similar person 1202. After that, the tracking operation for the person 1202 continues, which makes it impossible to track the person 1201 as the tracking target object.

As described above, since it is not possible to detect that the tracking target object is covered by the intruding object, if an object having a representative color or a feature value similar to that of the tracking target object exists in the vicinity of the tracking target object, the object different from the tracking target object is sometimes misidentified as the tracking target object.

### SUMMARY OF THE INVENTION

The present invention provides an object tracking device that is capable of detecting that an intruding object has entered an image frame of image data where a tracking target object is being tracked, a method of tracking an object, and a storage medium storing a program for causing a computer to execute the method.

In a first aspect of the present invention, there is provided an object tracking device that receives moving image data having a plurality of frames, and tracks an object which is to be tracked in the moving image data as a tracking target object, comprising a feature value calculation unit configured to set a plurality of sub areas in a preceding frame target area indicative of a position of the tracking target object in a preceding frame preceding a current frame of the moving image data, or in a current frame object area indicative of a position of the tracking target object in the current frame, and calculate a feature value of each of the sub areas, and an intruding object determination unit configured to determine that an intruding object different from the tracking target object has entered an area in which the tracking target object is positioned, in the current frame, when the feature value exceeds a first threshold value in at least one of the sub areas, and at the same time the number of the at least one of the sub areas does not reach a reference value.

In a second aspect of the present invention, there is provided a method of tracking an object, in which moving image data having a plurality of frames is received, and an object is tracked which is to be tracked in the moving image data as a tracking target object, comprising setting a plurality of sub areas in a preceding frame target area indicative of a position of the tracking target object in a preceding frame preceding a current frame of the moving image data, or in a current frame object area indicative of a position of the tracking target object in the current frame, and calculating a feature value of each of the sub areas, and determining that an intruding object different from the tracking target object has entered an area in which the tracking target object is positioned, in the current frame, when the feature value exceeds a first threshold value in at least one of the sub areas, and at the same time the number of the at least one of the sub areas does not reach a reference value.

In a third aspect of the present invention, there is provided a non-transitory computer-readable storage medium storing a computer-executable program for causing a computer to execute a method of tracking an object, in which moving image data having a plurality of frames is received, and an object is tracked which is to be tracked in the moving image data as a tracking target object, wherein the method comprises setting a plurality of sub areas in a preceding frame target area indicative of a position of the tracking target object in a preceding frame preceding a current frame of the moving image data, or in a current frame object area indicative of a position of the tracking target object in the current frame, and calculating a feature value of each of the sub areas, and determining that an intruding object different from the tracking target object has entered an area in which the tracking target object is positioned, in the current frame, when the feature value exceeds a first threshold value in at least one of the sub areas, and at the same time the number of the at least one of the sub areas does not reach a reference value.

According to the present invention, feature values are calculated for respective sub areas, and it is determined according to the feature values whether or not an intruding object enters the current frame area. Therefore, it is possible to detect the intruding object in the image frame of image data.

Further features of the present invention will become apparent from the following description of exemplary embodiments with reference to the attached drawings.

### BRIEF DESCRIPTION OF THE DRAWINGS

FIG. 1 is a block diagram of an object tracking device according to a first embodiment of the present invention.

FIG. 2A is a diagram illustrating preceding-frame target area data, and FIG. 2B is a diagram illustrating a matching area set in image data of the current frame.

FIG. 3A is a diagram illustrating an example of sub areas in the preceding-frame target area data, and FIG. 3B is a diagram illustrating an example of sub areas in the current-frame target area data.

FIG. 4 is a diagram useful in explaining motion vectors as feature values calculated by a feature value calculation section appearing in FIG. 1.

FIG. 5A is a diagram illustrating a sub area of the preceding frame, FIG. 5B is a diagram illustrating a sub area of the current frame corresponding to the sub area of the preceding frame shown in FIG. 5A and a search area, and FIG. 5C is a diagram illustrating a matching area.

FIG. 6 is a block diagram of a variation of the object tracking device according to the first embodiment of the present invention.

FIG. 7 is a block diagram of an object tracking device according to a second embodiment of the present invention.

FIG. 8 is a diagram useful in explaining calculation of an evaluation value (feature value) performed by a feature value calculation section appearing in FIG. 7.

FIG. 9A is a diagram illustrating a sub area, and FIG. 9B is a diagram illustrating a matching area set to the image data of the current frame.

FIG. 10 is a diagram useful in explaining calculation of reliability performed by a reliability calculation section appearing in FIG. 7.

FIG. 11 is a block diagram of a variation of the object tracking device according to the second embodiment of the present invention.

FIG. 12 is a diagram useful in explaining a problem of conventional tracking methods.

### DESCRIPTION OF THE EMBODIMENTS

The present invention will now be described in detail below with reference to the accompanying drawings showing embodiments thereof.

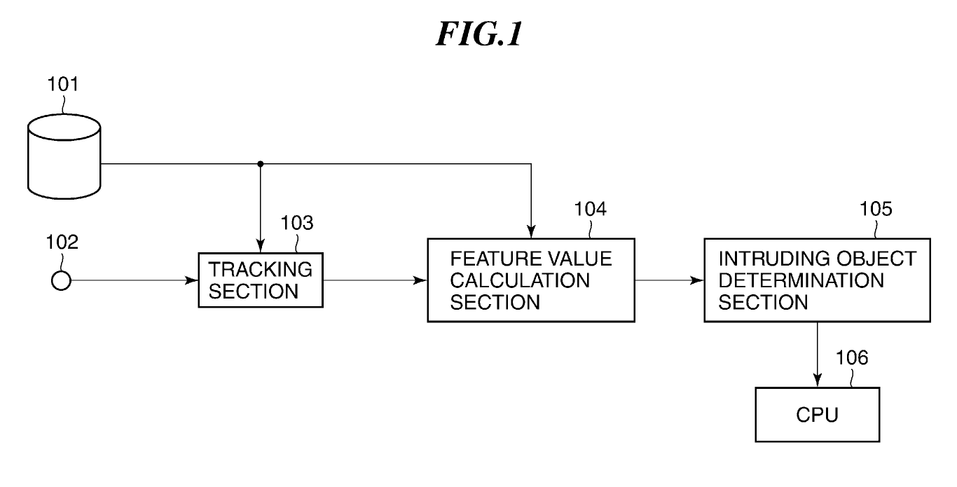

FIG. 1 is a block diagram of an object tracking device according to a first embodiment of the present invention.

Moving image data having a plurality of frames, for example, is input on a frame-by-frame basis to the object tracking device shown in FIG. 1. Image data of a latest frame input to the object tracking device is referred to as the image data of the current frame, and image data of a frame immediately preceding the current frame is referred to as the image data of the preceding frame.

The object tracking device includes a first memory section 101, and an input terminal 102 to which moving image data is input. The first memory section 101 stores image data of a tracking target object (object) out of the image data of the preceding frame, as preceding-frame target area data.

The object tracking device further includes a tracking section 103, a feature value calculation section 104, an intruding object determination section 105, and a CPU 106. The tracking section 103 receives image data of the current frame from the input terminal 102, and reads the preceding-frame target area data from the first memory section 101. Further, using the preceding-frame target area data, the tracking section 103 identifies an area of image data which is estimated to be a tracking target object, from the image data of the current frame, as current-frame target area data.

The tracking section 103 identifies the current-frame target area data by carrying out matching between the preceding-frame target area data and the image data of the current frame. For example, the tracking section 103 calculates a difference value between the preceding-frame target area data and the image data of the current frame on a pixel-by-pixel basis, and performs determination using the sum of the difference values to thereby identify the current-frame target area data.

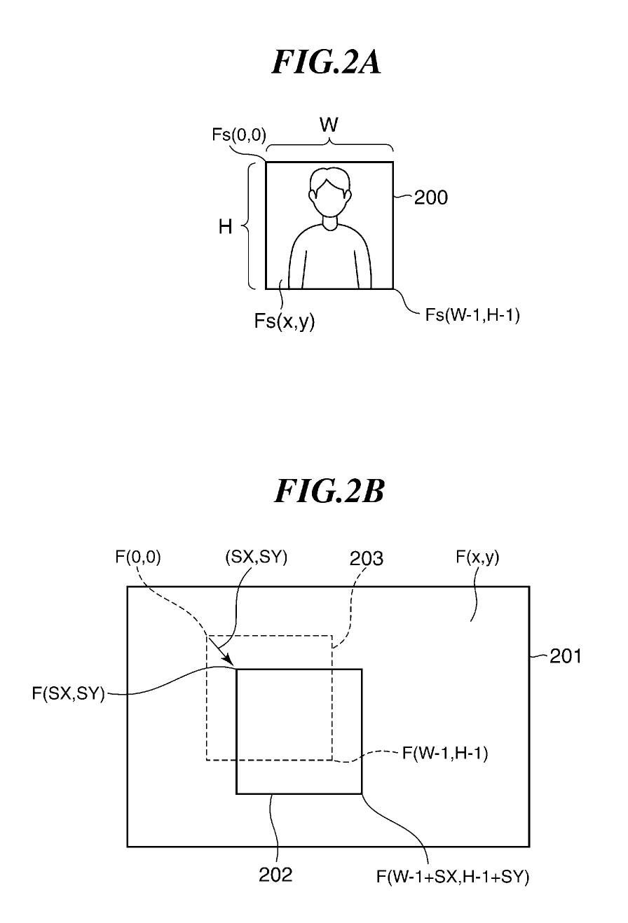

FIG. 2A is a diagram illustrating the preceding-frame target area data, and FIG. 2B is a diagram illustrating a matching area set in the image data of the current frame.

In FIG. 2A, the number of pixels in a horizontal direction in a preceding-frame target area data 200 is represented by W, the number of pixels in a vertical direction in the same is represented by H, and each pixel value within the preceding-frame target area data 200 is represented by Fs(x, y). For example, an upper left corner pixel value within the preceding-frame target area data 200 is expressed by Fs(0, 0), and a lower right corner pixel value is expressed by Fs(W−1, H−1).

In FIG. 2B, a matching area 202, which has the number of pixels in a horizontal direction set to W and the number of pixels in a vertical direction set to H, is set in image data 201 of the current frame, similarly to the preceding-frame target area data 200. A position of an area 203 in FIG. 2B indicates the position of the preceding-frame target area data 200 in the image data of the preceding frame. An amount of shift of a position of the matching area 202 from the position of the area 203 is expressed by (SX, SY).

Each pixel value within the image data 201 of the current frame is represented by F(x, y), with an upper left corner pixel value of the area 203 expressed by F(0, 0) and a lower right corner pixel value of the same expressed by F(W−1, H−1). An upper left corner pixel value of the matching area 202 which has been shifted from the area 203 by (SX, SY) is expressed by F(SX, SY), and a lower right corner pixel value of the same is expressed by F(W−1+SX, H−1+SY). Here, the tracking section 103 calculates a motion vector evaluation value SAD(SX, SY) as the sum of the absolute values of differences between each corresponding pixel values of the preceding-frame target area data 200 and the image data of the matching area 202 when the preceding-frame target area data 200 and the image data of the matching area 202 are placed in fully overlapping relationship, by the following equation (1):

$$SAD ( SX , SY ) = {\sum }_{y = 0}^{H - 1} {\sum }_{x = 0}^{W - 1} \vert Fs ( x , y ) - F ( x + SX , y + SY ) \vert \qquad ( 1 )$$

The tracking section 103 moves the matching area 202 to determine the position of the matching area 202 in which the motion vector evaluation value SAD(SX, SY) becomes the minimum, and sets the image data of the matching area 202 in the determined position as the current-frame target area data. However, when the minimum value of the motion vector evaluation value SAD(SX, SY) is larger than a predetermined tracking reference value, the tracking section 103 determines that detection of the tracking target object has failed.

The current-frame target area data is supplied from the tracking section 103 to the feature value calculation section 104. The feature value calculation section 104 reads the preceding-frame target area data from the first memory section 101. Further, the feature value calculation section 104 sets a plurality of sub areas in an image area indicated by the preceding-frame target area data. Further, the feature value calculation section 104 sets a plurality of sub areas in an image area represented by the current-frame target area data. Then, the feature value calculation section 104 calculates a feature value of each of the sub areas of the preceding and current frames.

The calculated feature values are supplied from the feature value calculation section 104 to the intruding object determination section 105. The intruding object determination section 105 determines based on the calculated feature values whether or not an intruding object overlaps the image area of the tracking target object, as described hereinafter, and supplies the result of determination to the CPU 106.

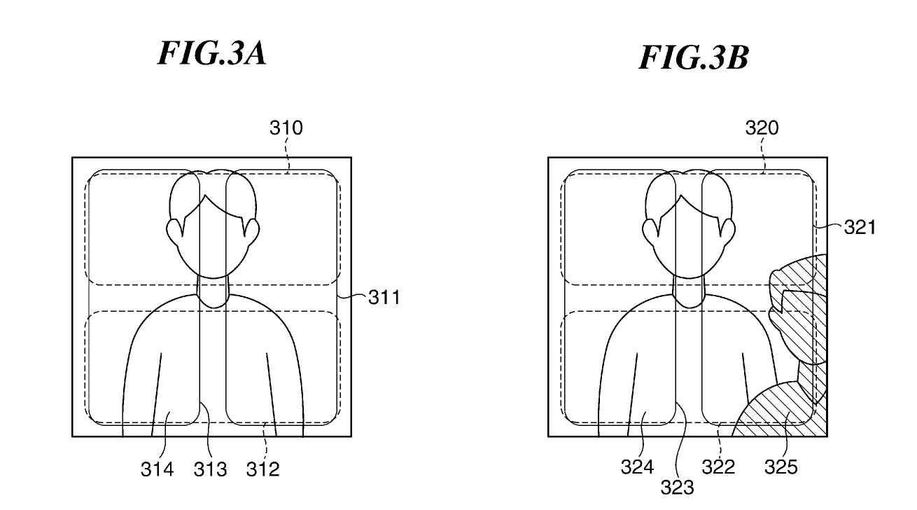

FIG. 3A is a diagram illustrating an example of the sub areas in the preceding-frame target area data, and FIG. 3B is a diagram illustrating an example of the sub areas in the current-frame target area data.

As shown in FIG. 3A, the feature value calculation section 104 sets four sub areas 310 to 313, each having a substantially rectangular shape, which correspond to an upper half, a right half, a lower half, and a left half of preceding-frame target area data 314, respectively. As shown in FIG. 3A, these sub areas 310 to 313 have portions overlapping each other.

Similarly, as shown in FIG. 3B, the feature value calculation section 104 sets four sub areas 320 to 323, each having a substantially rectangular shape, which correspond to an upper half, a right half, a lower half, and a left half of current-frame target area data 324, respectively. As shown in FIG. 3B, these sub areas 320 to 323 have portions overlapping each other. Positions of the sub areas 310 to 313 within the preceding-frame target area data 314 coincide with those of the sub areas 320 to 323 within the current-frame target area data 324, respectively. In the example shown in FIG. 3B, an intruding object 325 exists in part of the current-frame target area data 324. Note that the number and shape of the sub areas can be set as desired.

As described above, the feature value calculation section 104 calculates the feature value of each of the sub areas 310 to 313 of the preceding frame and the sub areas 320 to 323 of the current frame.

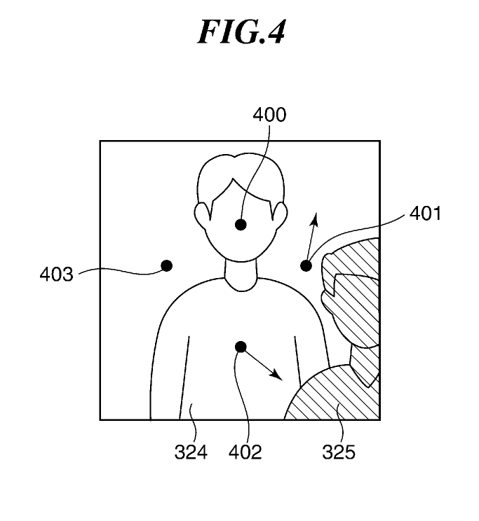

FIG. 4 is a diagram useful in explaining motion vectors as feature values calculated by the feature value calculation section 104.

In FIG. 4, a motion vector of the sub area 310 of the preceding frame is indicated by an upper half motion vector 400. Further, a motion vector of the sub area 311 of the preceding frame is indicated by a right half motion vector 401. Further, a motion vector of the sub area 312 of the preceding frame is indicated by a lower half motion vector 402. Further, a motion vector of the sub area 313 of the preceding frame is indicated by a left half motion vector 403.

Although various methods have been known as a method of calculating a motion vector, for example, in the present embodiment, the following method is used.

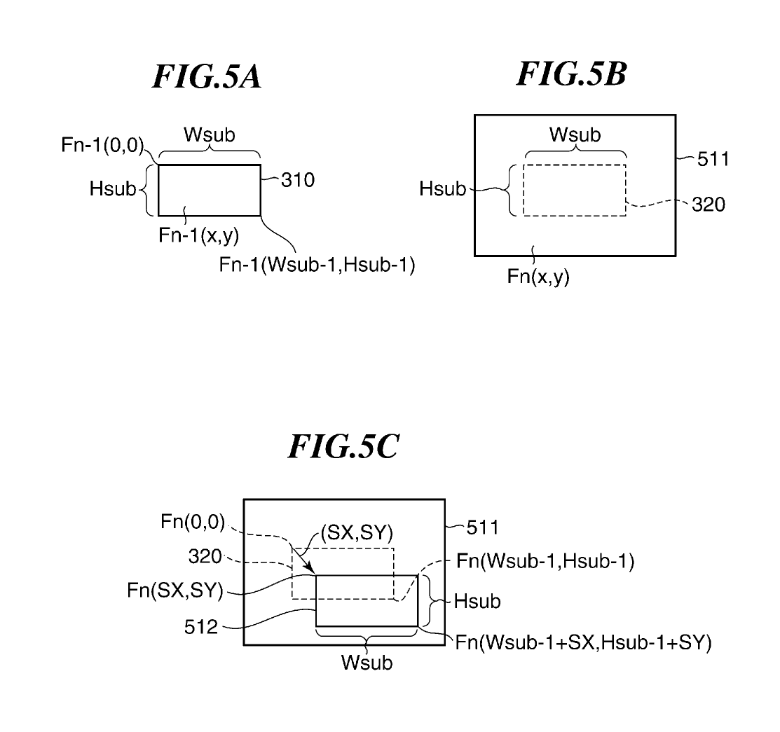

FIG. 5A is a diagram illustrating a sub area of the preceding frame, FIG. 5B is a diagram illustrating a sub area of the current frame corresponding to the sub area of the preceding frame shown in FIG. 5A and a search area, and FIG. 5C is a diagram illustrating a matching area.

In FIG. 5A, the number of pixels in a horizontal direction in the sub area of the preceding frame is represented by Wsub, and the number of pixels in the vertical direction in the same is represented by Hsub, and a pixel value of each pixel is defined as Fn−1(x, y). Here, a description will be given of the upper half sub area 310, by way of example.

As shown in FIG. 5B, the feature value calculation section 104 sets a search area 511 larger than the sub area 320 in association with the upper half sub area 320 of the current frame, in the image data of the current frame. As shown in FIG. 5C, the feature value calculation section 104 sets, similarly to the sub area 320, a matching area 512 having the number of pixels in a horizontal direction set to Wsub and the number of pixels in a vertical direction set to Hsub, within the search area 511. An amount of shift of the position of the matching area 512 from the position of the sub area 320 is expressed by (SX, SY).

A pixel value of each pixel within the image data of the preceding frame is defined as Fn−1(x, y), and a pixel value of each pixel within the image data of the current frame is defined as Fn(x, y). The upper left corner pixel value of the sub area 310 of the preceding-frame target area data is expressed by Fn−1(0, 0) and the lower right corner pixel value of the same is expressed by

Fn−1(Wsub−1, Hsub−1). Further, the upper left corner pixel value of the sub area 320 of the current-frame target area data is expressed by Fn(0, 0) and the lower right corner pixel value of the same is expressed by Fn(Wsub−1, Hsub−1). Accordingly, the upper left corner pixel value of the matching area 512 shifted from the sub area 320 by (SX, SY) is expressed by Fn(SX, SY), and the lower right corner pixel value of the same is expressed by Fn(Wsub−1+SX, Hsub−1+SY). Here, the feature value calculation section 104 calculates a motion vector evaluation value SAD(SX, SY) as the sum of the absolute values of differences of each corresponding pixel values of the image data of the sub area 310 of the preceding frame and the image data of the matching area 512 assuming that the image data of the sub area 310 of the preceding frame and the image data of the matching area 512 are placed in fully overlapping relationship, by the following equation (2).

$$SAD ( SX , SY ) = {\sum }_{y = 0}^{Hsub - 1} {\sum }_{x = 0}^{Wsub - 1} \vert {F}_{n - 1} ( x , y ) - {F}_{n} ( x + SX , y + SY ) \vert \qquad ( 2 )$$

Then, the feature value calculation section 104 determines a motion vector V(SX, SY) which makes minimum the motion vector evaluation value SAD(SX, SY) calculated by the equation (2), as the motion vector 400 of the sub area 310 of the preceding frame. Note that the motion vector V(SX, SY) is defined by a combination of the shift amount (SX, SY) and a direction of the shift. Similarly, the feature value calculation section 104 determines a motion vector of each of the sub areas 311 to 313 of the preceding frame shown in FIG. 3A. In the present embodiment, the matching area is set in the image data of the current frame with reference to the position of the sub area of the preceding frame, and then the motion vector of the sub area of the preceding frame is calculated. However, this is not limitative, but the matching area may be set in the image data of the preceding frame with reference to the position of the sub area of the current frame, and the motion vector of the sub area of the current frame may be calculated.

If an intruding object does not exist in any of the sub areas of the current frame, the correlation between an object within a sub area of the preceding frame and an object within a corresponding sub area of the current frame is high, and at the same time a shift of the position of the object between the sub areas is small. Therefore, in this case, the magnitude of the motion vector V(SX, SY), i.e. the shift amount (SX, SY), which makes minimum the motion vector evaluation value SAD(SX, SY) is small.

However, when an intruding object appears in any one of sub areas of the current frame, the search area 511 no longer contains a sub area which has a high correlation with the sub area of the preceding frame corresponding to the sub area of the current frame. Therefore, the position of the matching area in which the motion vector evaluation value SAD(SX, SY) is minimum is liable to appear in a position irrelevant to an actual position of the tracking target object, and the magnitude of the motion vector V(SX, SY) i.e. the shift amount (SX, SY) is more likely to assume a relatively high value.

The feature value calculation section 104 calculates the motion vector as the feature value for each of the sub areas as described above, and supplies the calculated motion vector to the intruding object determination section 105. The intruding object determination section 105 has a predetermined first threshold value of the magnitude of the motion vector set therein in advance, and if there is any one sub area in which the magnitude of the motion vector is larger than the first threshold value thereof, the intruding object determination section 105 determines that an intruding object is in the image area of the tracking target object.

Further, also when there are two sub areas with the magnitudes of the respective motion vectors larger than the first threshold value, and these sub areas are adjacent to each other, the intruding object determination section 105 determines that an intruding object is in the image area of the tracking target object. The state where the sub areas with the magnitudes of the respective motion vectors larger than the first threshold value are adjacent to each other is, for example, a state where the magnitudes of the motion vectors 400 and 401 in FIG. 4 are larger than the first threshold value. Further, respective states where the magnitudes of the motion vectors 401 and 402, the magnitudes of the motion vectors 402 and 403, and the magnitudes of the motion vectors 403 and 400 are larger than the first threshold value are each also the state where the sub areas with the magnitudes of the respective motion vectors larger than the first threshold value are adjacent to each other. Note that under other conditions than the above, the intruding object determination section 105 determines that no intruding object is in the image area of the tracking target object.

Here, although the description has been given of the case where the number of sub areas is four, by way of example, it is also possible to similarly perform the determination even when the number of sub areas is more than four. That is, even when the number of sub areas is more than four, if the magnitude of the motion vector in any of the sub areas exceeds the first threshold value thereof, it is determined that an intruding object is in the image area of the tracking target object. Note that if there are a plurality of sub areas in which the magnitudes of the respective motion vectors are larger than the first threshold value, it is preferable to add a condition that all of the sub areas are adjacent to each other to the conditions for determining that an intruding object is in the image area of the tracking target object. This is because it is unlikely that different intruding objects simultaneously enter the image area of the tracking target object from a plurality of directions, and if the magnitudes of the motion vectors in the sub areas which are not adjacent to each other simultaneously exceed the first threshold value, it is considered that some other factor is the cause.

Further, if the magnitudes of the motion vectors in more than half of sub areas are larger than the first threshold value, it is determined that no intruding object is in the image area of the tracking target object but the tracking section 103 has failed in the tracking operation. This is because in this case, it is presumed that no intruding object has entered the image area of the tracking target object but there is a high possibility that the tracking section 103 has erroneously detected a different object as the tracking target object. Note that although more than half of the sub areas is set as a reference value for determination in the above, it is preferable to empirically determine a suitable reference value depending on the size of an object, the number of sub areas, or whether or not the object is moving.

Instead of comparing the magnitude of the motion vector with the threshold value thereof, it may be determined that an intruding object is in the image area of the tracking target object when the minimum value of the motion vector evaluation value SAD(SX, SY) is not smaller than a predetermined value thereof. This is because when an intruding object appears in a sub area of the current frame, the correlation between the sub area of the preceding frame and that of the current frame becomes low, and hence the minimum value of the motion vector evaluation value SAD(SX, SY) has a high possibility of becoming a relatively large value.

As described above, the intruding object determination section 105 determines whether or not any intruding object is in the image area of the tracking target object and notifies the CPU 106 of the result of determination. If it is determined by the intruding object determination section 105 that no intruding object is in the image area of the tracking target object, the CPU 106 updates the preceding-frame target area data stored in the first memory section 101 using the current-frame target area data obtained by the tracking section 103. Then, the CPU 106 sets image data of the newly read frame as the image data of the current frame, and repeats the above-described processing operations. On the other hand, if it is determined by the intruding object determination section 105 that an intruding object is in the image area of the tracking target object, the CPU 106 holds the preceding-frame target area data stored in the first memory section 101 as it is. Then, the CPU 106 sets image data of the newly read frame as the image data of the current frame, and repeats the above-described process. Further, if it is determined that the tracking section 103 has failed in detection of the tracking target object, the CPU 106 deletes the preceding-frame target area data stored in the first memory section 101, and stops the tracking processing until a new tracking target object is designated by the user's instruction.

Note that an operation mode in which the above-described sequence of processing operations from the tracking of a tracking target object to the determination of entrance of an intruding object is performed is referred to as the tracking operation mode.

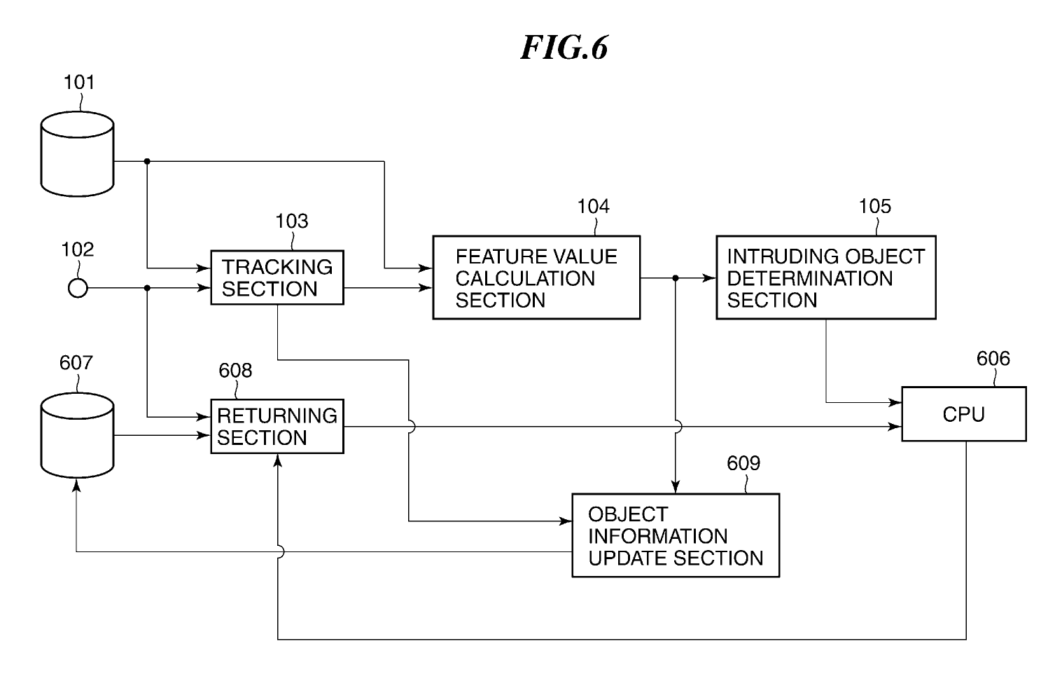

FIG. 6 is a block diagram of a variation of the object tracking device according to the first embodiment of the present invention. This object tracking device has a feature that switches the operation mode from the tracking operation mode to a search mode, when it is determined that an intruding object is in the image area of the tracking target object. The search mode is used for confirming that the intruding object has disappeared from the image area of the tracking target object, and then returning to the tracking operation mode.

In FIG. 6, the same component elements as appearing in FIG. 1 are denoted by the same reference numerals.

Referring to FIG. 6, the object tracking device further includes a second memory section 607, a returning section 608, and an object information update section 609. Note that a CPU appearing in FIG. 6 is different from the CPU 106 appearing in FIG. 1 in its functions, and hence it is denoted by reference numeral 606.

The second memory section 607 stores image data for use in returning to the tracking operation mode. The object information update section 609 updates the image data according to the feature value output from the feature value calculation section 104. For example, if all of the calculated magnitudes of the motion vectors in the set sub areas are not larger than a predetermined second threshold value of the magnitude of the motion vector, the object information update section 609 stores the current-frame target area data obtained by the tracking section 103 in the second memory section 607 as new image data for use in returning to the tracking operation mode. Note that the second threshold value is lower than the first threshold value. This is to maintain accuracy in object information for use in the search mode, described hereinafter, by making the condition set by the second threshold value more strict.

When the CPU 606 recognizes that an intruding object has entered an area of a tracking target object based on the result of determination by the intruding object determination section 105, the CPU 606 switches the operation mode from the tracking operation mode to the search mode. Then, in the search mode, the CPU 606 operates the returning section 608.

The returning section 608 performs the same processing as performed by the tracking section 103 to thereby identify an area of image data, which is most approximate to the image data stored in the second memory section 607, from the image data of the current frame newly obtained after switching the operation mode to the search operation mode. However, although the tracking section 103 reads the preceding-frame target area data from the first memory section 101, the returning section 608 reads the image data stored in the second memory section 607 for use in returning to the tacking operation mode.

The returning section 608 sets a matching area with reference to a position of the image data for use in returning to the tacking operation mode, in the image data of the original frame, and sets each pixel value within the image data stored in the second memory section 607 for use in returning to the tacking operation mode, as Fs(x, y), and each pixel value within the image data of the current frame, as F(x, y). Further, the returning section 608 determines a motion vector evaluation value SAD(SX, SY) as the sum of the absolute values of differences between each corresponding pixel values of the image data stored in the second memory section 607 for use in returning to the tracking operation mode and the image data of the current frame assuming that the image data for use in returning to the tracking operation mode and the image data of the matching area set in the image data of the current frame are placed in fully overlapping relationship, by the above-mentioned equation (1).

If the minimum value of the motion vector evaluation value SAD(SX, SY) is not larger than a third threshold value, the returning section 608 determines that the tracking target object exists in the matching area at the time, whereas if the minimum value of the motion vector evaluation value SAD(SX, SY) is larger than the third threshold value, the returning section 608 determines that the tracking target object cannot be detected. If it is determined by the returning section 608 that the tracking target object is identified, the CPU 606 updates the preceding-frame target area data stored in the first memory section 101 using the image data of the matching area set by the returning section 608, and then returns the operation mode to the tracking operation mode. On the other hand, if it is not determined by the returning section 608 that the tracking target object is identified, the CPU 606 continues the search mode.

By the way, the tracking target object sometimes changes not only the position but also the orientation thereof. If the tracking target object is a person, he/she sometimes changes his/her pose or facial expressions. Therefore, a reference value of the motion vector evaluation value SAD(SX, SY) with reference to which failure of identification of the tracking target object is determined is set to a relatively large value, whereby it is made possible for the tracking section 103 to detect the tracking target object even when the above-mentioned change or the like has occurred to the tracking target object.

On the other hand, the returning section 608 sets the third threshold value to a value smaller than the predetermined tracking reference value for determining the failure of identification of the tracking target object. This is because when an intruding object is in an area of the tracking target object, if the returning section 608 determines whether or not the tracking target object is identified, with reference to the same value as set by the tracking section 103, another object similar to the tracking target object may be erroneously detected as the tracking target object. By setting the reference value for determining whether or not the tracking target object is identified as a more strict value than that used by the tracking section 103, it is possible to reduce the possibility of erroneously tracking an object other than the tracking target object.

Although the tracking section 103, the feature value calculation section 104, and the returning section 608 are described as separate circuits, it is also possible to realize these circuits by one circuit, since they are circuits for computations of the same type.

As described above, in the first embodiment and the variation thereof, a plurality of sub areas are set with respect to the preceding-frame target area data, the feature value is calculated with respect to each sub area, and it is determined whether or not an intruding object has entered the current frame area according to the determined feature value. Therefore, it is possible to detect an intruding object.

Next, a description will be given of an object tracking device according to a second embodiment of the present invention.

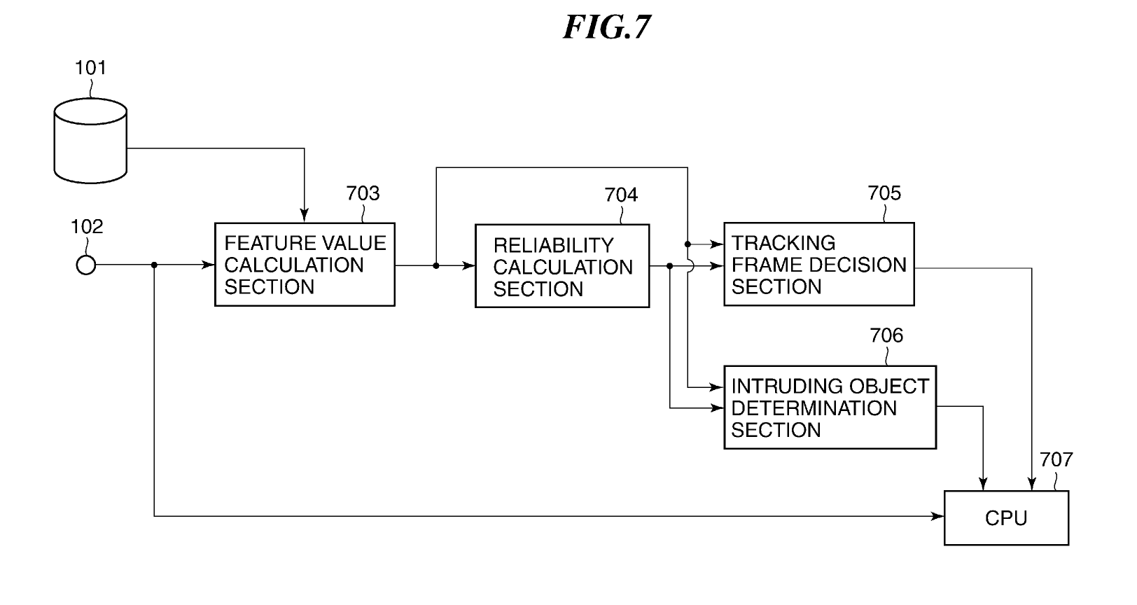

FIG. 7 is a block diagram of the object tracking device according to the second embodiment of the present invention. An object tracking device shown in FIG. 7 includes the same first memory section 101 and the input terminal 102 as those of the object tracking device shown in FIG. 1.

The illustrated object tracking device includes a feature value calculation section 703 which sets a plurality of sub areas in the preceding-frame target area data stored in the first memory section 101. Further, the feature value calculation section 703 searches the image data of the current frame on a sub area-by-sub area basis, for an area most approximate to the sub area, and outputs the evaluation value used in the search as the feature value.

A reliability calculation section 704 calculates the reliability of the feature value obtained from each sub area. A tracking frame decision section 705 decides a position of a tracking frame according to the feature value of which the reliability is high. Further, an intruding object determination section 706 performs determination of entrance of an intruding object according to the feature value of which the reliability is low.

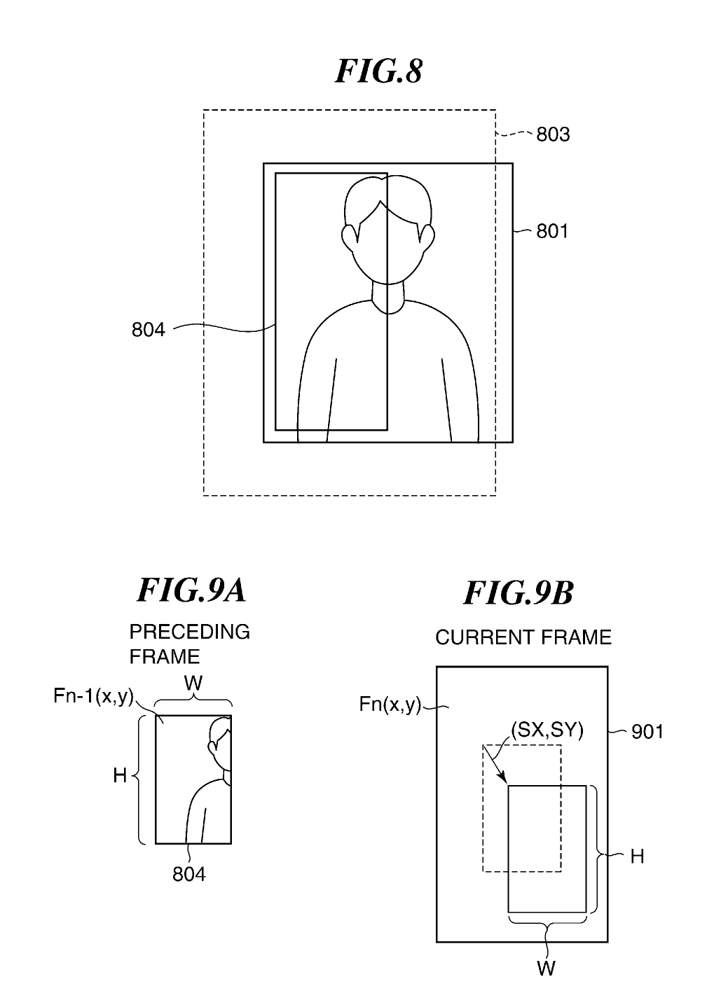

FIG. 8 is a view useful in explaining calculation of the evaluation value (feature value) performed by the feature value calculation section 703 appearing in FIG. 7.

The feature value calculation section 703 calculates the sum of the absolute values of differences of the pixel values between the image data items, as the evaluation value indicative of the feature value, as described hereinafter. Now, it is assumed that a plurality of sub areas are set in the preceding-frame target area data, and reference numeral 804 denotes one of the set sub areas. The position of an illustrated tracking frame 801 indicates a position of the tracking frame in the image data of the preceding frame. The feature value calculation section 703 sets an area 803 which is larger than the sub area 804 in the preceding frame, around the sub area 804. The feature value calculation section 703 sets a search area in the same position and of the same size as the area 803 in the image data of the current frame. Then, the feature value calculation section 703 calculates a position of an area most approximate to the sub area 804 in the preceding frame, within the search area in the image data of the current frame. To calculate the position most approximate to the sub frame 804, the sum of the absolute values of differences is calculated.

FIG. 9A is a diagram illustrating a sub area, and FIG. 9B a diagram illustrating a matching area set in the image data of the current frame.

In FIG. 9A, the number of pixels in a horizontal direction in the sub area 804 of the preceding frame is represented by W, the number of pixels in a vertical direction in the same is represented by H, and a pixel value of each pixel within the sub area 804 is defined by Fn−1(x, y).

Further, in FIG. 9B, the feature value calculation section 703 sets a matching area having W pixels in a horizontal direction and H pixels in a vertical direction in a given position within a search area 901 set in the current frame. A pixel value of each pixel within the matching area is defined as F(x, y). The feature value calculation section 703 calculates the difference between a pixel value in the sub area 804 of the preceding frame and a pixel value in the matching area, on a pixel-by-pixel basis, and integrates the absolute values of the differences by the above equation (1) to thereby obtain the evaluation value SAD(SX, SY). An amount of shift of the matching area from the sub area 804 is represented by (SX, SY). That is, assuming that a pixel value in the sub area 804 is represented by Fn−1(x, y), a pixel value in the matching area is expressed by Fn(x+SX, y+SY).

The feature value calculation section 703 determines a position of the matching area in which the motion vector evaluation value SAD(SX, SY) expressed by the equation (1) becomes the minimum, and a combination of the shift amount (SX, SY) of the matching area at the time and a direction of the shift defines a motion vector V(SX, SY). Then, the feature value calculation section 703 outputs a combination of the motion vector and the minimum evaluation value as the feature value.

The feature value calculation section 703 outputs the same number of feature values as the number of sub areas. For example, when the number of sub areas is four as in FIGS. 2A and 2B, referred to hereinabove, the feature value calculation section 703 outputs four sets of features values. In the following description, a description will be given of a case where the number of sub areas is four.

The reliability calculation section 704 calculates reliability based on the evaluation values of the plurality of feature values.

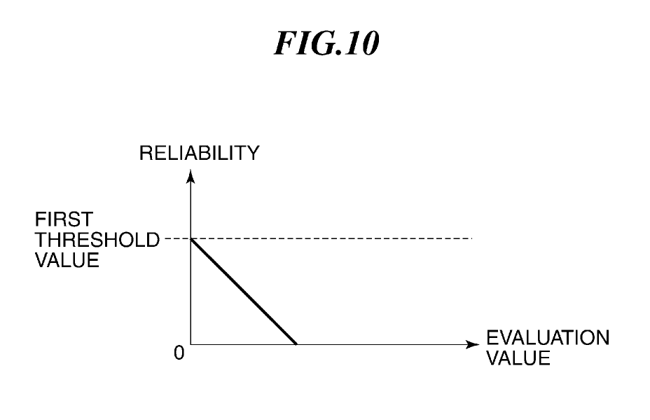

FIG. 10 is a diagram useful in explaining how to calculate reliability performed by the reliability calculation section 704 appearing in FIG. 7.

As shown in FIG. 10, the reliability calculation section 704 calculates the difference between a first threshold value thereof set in advance and the evaluation value, on an evaluation value-by-evaluation value basis, by the following equation (3), and sets the calculated difference as a reliability.

reliability=(first threshold value)−(evaluation value) (3)

Note that if the calculation gives a value less than zero, the reliability is set to zero.

Next, the tracking frame decision section 705 decides a position of the tracking frame in the current frame according to the feature values output from the feature value calculation section 703 and the reliabilities output from the reliability calculation section 704.

For example, the tracking frame decision section 705 determines weighting coefficients from respective ratios of reliabilities associated with the motion vectors obtained from the sub areas to the total of the reliabilities, and determines the motion vector of the tracking frame by calculating a weighted average of the motion vectors using the weighting coefficients. Then, the tracking frame decision section 705 decides a position moved (shifted) from the position of the preceding-frame target area data in the preceding frame, by the above-mentioned motion vector of the tracking frame, as a position of the tracking frame in the current frame.

The intruding object determination section 706 determines whether or not an intruding object exists, according to each reliability output from the reliability calculation section 704.

For example, if the reliability is lower than a predetermined second threshold value thereof in only one of the four sub areas, the intruding object determination section 706 determines that an intruding object has entered the tracking frame for tracking a tracking target object.

Further, if the reliability is lower than the second threshold value thereof in two of the four sub areas and these two sub areas are adjacent to each other, the intruding object determination section 706 also determines that an intruding object has entered the tracking frame for tracking a tracking target object. Note that the two sub areas which are adjacent to each other are e.g. the areas associated with the motion vectors 400 and 401, the areas associated with the motion vectors 401 and 402, the areas associated with the motion vectors 402 and 403, and the areas associated with the motion vectors 403 and 400, in FIG. 4. Similarly to the first embodiment, even when the number of sub areas is more than four, it is possible to similarly perform the determination. Further, when the number of sub areas in which the magnitude of the motion vector exceeds the first threshold value thereof reaches a reference value (e.g. more than half of the total number of sub areas), it is determined that the tracking frame has been set on an object different from the tracking target object and hence the tracking operation has failed.

Further, as shown in FIG. 7, the tracking frame information indicative of the tracking frame decided by the tracking frame decision section 705 and the result of determination by the intruding object determination section 706 are supplied to a CPU 707. The CPU 707 performs the control of the tracking processing according to the result of determination by the intruding object determination section 706, similarly to the CPU 106 in FIG. 1.

The operation mode in which above-described sequence of processing operations from the tracking of a tracking target object to the determination of entrance of an intruding object is performed is referred to as the tracking operation mode, as mentioned hereinabove.

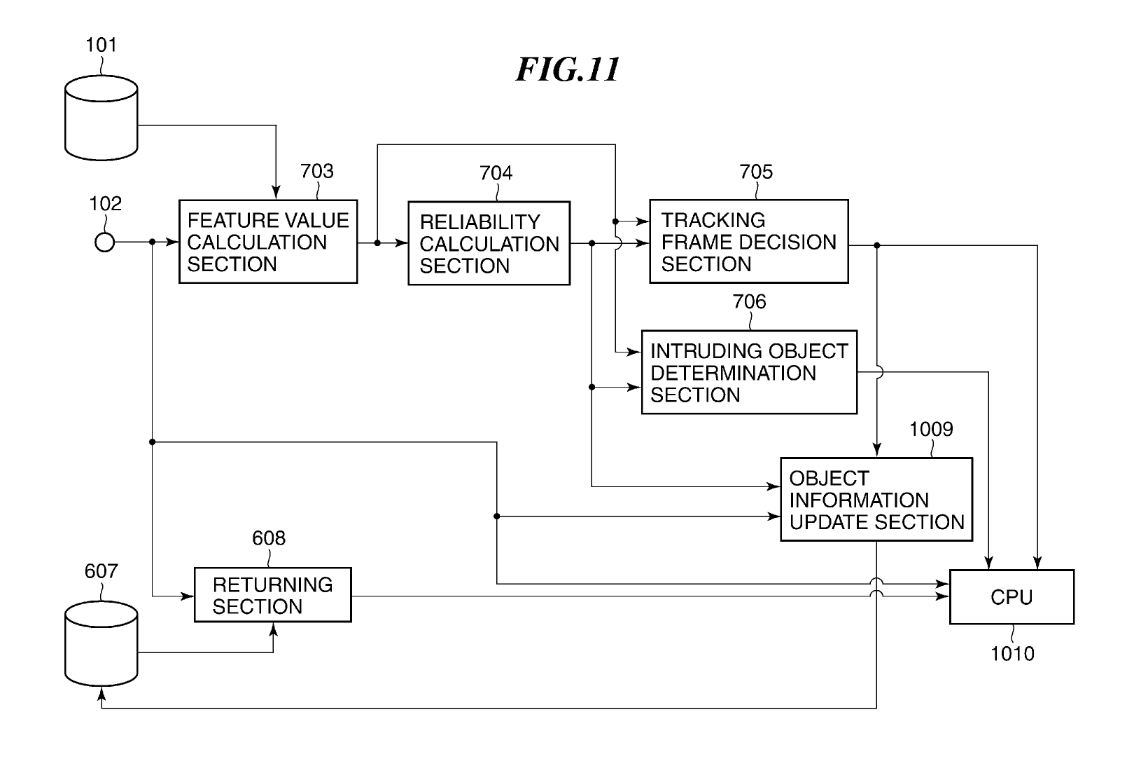

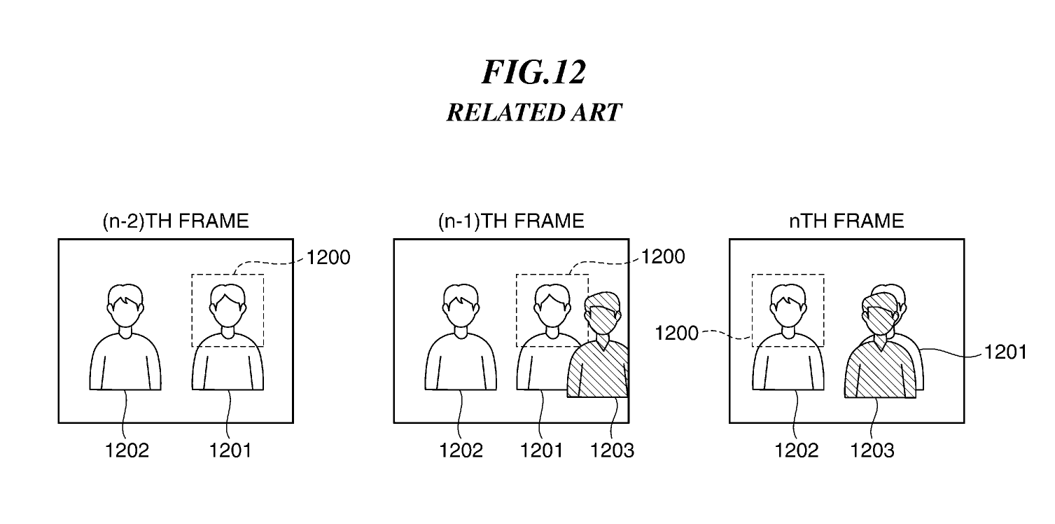

FIG. 11 is a block diagram of a variation of the object tracking device according to the second embodiment of the present invention. In FIG. 11, the same component elements as those of the object tracking device shown in FIG. 7 are denoted by the same reference numerals. Further, in FIG. 11, the same component elements as those of the object tracking device shown in FIG. 6 are denoted by the same reference numerals.

Referring to FIG. 11, when the intruding object determination section 706 determines that an intruding object has entered, a CPU 1010 switches the operation mode to the search mode. The processing in the search mode has been described hereinabove with reference to FIG. 5, and hence description thereof is omitted.

An object information update section 1009 updates the second memory section 607 according to the reliabilities calculated by the reliability calculation section 704. For example, if the above-mentioned reliabilities in all of the sub areas are equal to or higher than a predetermined third threshold value of the reliability, the object information update section 1009 stores image data in the tracking frame of the current frame, which is in the position decided by the tracking frame decision section 705, in the second memory section 607, to thereby update the second memory section 607. Note that the third threshold value of the reliability is set to a higher value than the second threshold value of the same. This is to maintain accuracy in object information for use in the search mode, described hereinafter, by making the condition set by the third threshold value more strict.

Although in the above-described first and second embodiments, a motion vector and a combination of a motion vector and a minimum evaluation value in each sub area are respectively used, as the feature value for use in the determination of entrance of an intruding object, there may be used a feature value other than a motion vector or a combination of a motion vector and a minimum evaluation value.

For example, the motion vector in each sub area may be stored e.g. in a memory, and it may be determined whether or not an angular difference between the direction of the motion vector determined when the determination of entrance of an intruding object was performed in the preceding frame and the direction of the motion vector determined when the determination of entrance of an intruding object is performed in the current frame is not smaller than a predetermined threshold.

Further, the absolute sum of differences between brightness values of the preceding frame and the current frame may be determined for each sub area, and it may be determined whether or not a normalized value of the absolute sum normalized by the number of pixels is not smaller than a predetermined threshold value.

As described above, also in the second embodiment, it is determined according to the feature value determined for each sub area whether or not an intruding object has entered the current frame area, which makes it possible to easily detect an intruding object, and therefore, it is possible to positively track a tracking target object.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, the functions of the above-described embodiments may be applied to an object tracking method, and the object tracking method may be executed by a computer. Further, an object tracking program having the functions of the above-described embodiments may be caused to be executed by a computer. In this case, the object tracking method and program include at least a tracking step, a feature value calculation step, and an intruding object determination step, or the feature value calculation step, a reliability calculation step, a frame determination step, and the intruding object determination step. Note that the object tracking program is recorded e.g. in a computer-readable non-volatile storage medium.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

This application claims the benefit of Japanese Patent Application No. 2010-264958, filed Nov. 29, 2010, and Japanese Patent Application No. 2011-249614, filed Nov. 15, 2011, which are hereby incorporated by reference herein in its entirety.

What is claimed is:

1. An object tracking device that receives moving image data having a plurality of frames, and tracks an object which is to be tracked in the moving image data as a tracking target object, comprising:
a feature value calculation unit configured to set a plurality of sub areas in a preceding frame target area indicative of a position of the tracking target object in a preceding frame preceding a current frame of the moving image data, or in a current frame target area indicative of a position of the tracking target object in the current frame, and calculate a feature value of each of the sub areas; and
an intruding object determination unit configured to determine that an intruding object different from the tracking target object has entered an area in which the tracking target object is positioned, in the current frame, when the feature value exceeds a first threshold value in at least one of the sub areas, and at the same time the number of the at least one of the sub areas does not reach a reference value.

2. The object tracking device according to claim 1, further comprising a tracking unit configured to identify a position of the tracking target object in the current frame, and
wherein said intruding object determination unit determines that said tracking unit has failed in identifying the position of the tracking target object in the current frame, when the feature value exceeds the first threshold value in at least one of the sub areas, and at the same time the number of the at least one of the sub areas reaches the reference value.

3. The object tracking device according to claim 2, further comprising:
a memory that stores image data of the tracking target object in the current frame identified by said tracking unit;
a control unit configured to perform a search mode when it is determined by said intruding object determination unit that the intruding object has entered; and
a search unit configured to be operable when the search mode is performed, to identify a position of the tracking target object from the current frame obtained after performing the search mode, using the image data stored in said memory, and
wherein said search unit identifies the position of the tracking target object using a condition more strict than that used by said tracking unit.

4. The object tracking device according to claim 3, further comprising an update unit configured to update the image data stored in said memory according to the feature value associated with the tracking target object of which the position in the current frame has been identified by said tracking unit.

5. The object tracking device according to claim 4,
wherein said intruding object determination unit determines a motion vector of each sub area, and sets the motion vector as the feature value, and
wherein when all of the respective magnitudes of the feature values of sub areas associated with the tracking target object of which the position in the current frame has been identified by said tracking unit are equal to or smaller than a second threshold value, said update unit updates the image data stored in said memory using the image data of the tracking target object of which the position in the current frame has been identified by said tracking unit.

6. The object tracking device according to claim 1, wherein said intruding object determination unit determines a motion vector of each sub area, and sets the motion vector as the feature value of the sub area.

7. The object tracking device according to claim 2, wherein when said intruding object determination unit determines that said tracking unit has failed in identifying the position of the tracking target object in the current frame, said tracking unit stops identifying the position of the tracking target object in the moving image data.

8. A method of tracking an object, in which moving image data having a plurality of frames is received, and an object is tracked which is to be tracked in the moving image data, as a tracking target object, comprising:
setting a plurality of sub areas in a preceding frame target area indicative of a position of the tracking target object in a preceding frame preceding a current frame of the moving image data, or in a current frame target area indicative of a position of the tracking target object in the current frame, and calculating a feature value of each of the sub areas; and
determining that an intruding object different from the tracking target object has entered an area in which the tracking target object is positioned, in the current frame, when the feature value exceeds a first threshold value in at least one of the sub areas, and at the same time the number of the at least one of the sub areas does not reach a reference value.

9. A non-transitory computer-readable storage medium storing a computer-executable program for causing a computer to execute a method of tracking an object, in which moving image data having a plurality of frames is received, and an object is tracked which is to be tracked in the moving image data, as a tracking target object,
wherein the method comprises:
setting a plurality of sub areas in a preceding frame target area indicative of a position of the tracking target object in a preceding frame preceding a current frame of the moving image data, or in a current frame target area indicative of a position of the tracking target object in the current frame, and calculating a feature value of each of the sub areas; and
determining that an intruding object different from the tracking target object has entered an area in which the tracking target object is positioned, in the current frame, when the feature value exceeds a first threshold value in at least one of the sub areas, and at the same time the number of the at least one of the sub areas does not reach a reference value.
